(19) United States
(12) Patent Application Publication
(10) Pub. No.: US 2025/0034776 A1
(43) Pub. Date: Jan. 30, 2025

(54) CREATING OPERATING SESSION OF A COMMERCIAL LAUNDRY APPLIANCE UTILIZING LIGHTING SEQUENCES

(71) Applicant: Haier US Appliance Solutions, Inc., Wilmington, DE (US)

(72) Inventors: MyungGeon Chung, Seoul (KR); Abdelghani Elfarra, Louisville, KY (US)

(21) Appl. No.: 18/357,369

(22) Filed: Jul. 24, 2023

(51) Int. Cl. D06F 34/04; D06F 33/32; D06F 34/32; H05B 47/165; H05B 47/175

(52) U.S. Cl. CPC D06F 34/04; D06F 33/32; D06F 34/32; H05B 47/165; H05B 47/175; D06F 2101/00; D06F 2105/58

(57) ABSTRACT

A method using a remote server and a remote user device to operate a laundry appliance includes using the remote user device to communicate an appliance identifier to the remote server. The remote server communicates, to the laundry appliance, a target illumination sequence to be generated by a lighting system of the laundry appliance. The remote user device records and transmits a recorded illumination sequence generated by the lighting system of the laundry appliance and the remote server sends a command to the laundry appliance to initiate an operating cycle if the target illumination sequence matches the recorded illumination sequence.

### FIELD OF THE INVENTION

The present subject matter relates generally to laundry treatment appliances, and more particularly to methods of initiating commercial laundry treatment operations utilizing a blinking light pattern.

### BACKGROUND OF THE INVENTION

Laundry appliances are commonly used in shared use or pay-per-use commercial environments. For example, certain commercial laundry appliances, such as washing machines and clothes dryers within a laundromat, dormitory, or apartment building, are used by a large number of users. Similarly shared use arrangements are becoming more common in light of the rise of shared living arrangements, home rental services, and other shared appliance situations. In order to secure use of a particular laundry appliance for an operating cycle or laundry session, users often pay a fee for a particular number of cycles or a specific amount of laundry time for a particular laundry unit. For example, users commonly have software applications on their cell phones that are loaded with money or connected to a credit card for purchasing and commissioning one or more laundry appliances for use.

Notably, the commissioning of an appliance frequently requires direct user interaction between the user and the appliance. In this regard, a user must input the cycle settings or otherwise interact with the control panel. In addition, various appliance regulations or protocols may require a user to physically press a start button, as this ensures that a user is physically present and reduces the likelihood of operating the appliance in a hazardous situation, e.g., when a child is inside. Moreover, in light of the rise in infectious diseases, users may not wish to touch such high traffic areas of a commercial laundry appliance. In addition, it is burdensome for a user to use a mobile phone to search for and commission an appliance and use a separate appliance control panel to initiate an operating cycle.

Accordingly, systems and methods for facilitating improved commissioning of commercial laundry appliances would be useful. In particular, a method for starting a commercial laundry session with a particular appliance without interacting directly with the control panel would be particularly beneficial.

### BRIEF DESCRIPTION OF THE INVENTION

Aspects and advantages of the invention will be set forth in part in the following description, or may be obvious from the description, or may be learned through practice of the invention.

In one exemplary embodiment, a method of using a remote server to operate a laundry appliance is provided. The remote server is in operative communication with the laundry appliance and a remote user device through a network. The method includes communicating, to the laundry appliance, a target illumination sequence to be generated by a lighting system of the laundry appliance, receiving, from the remote user device, a recorded illumination sequence generated by the lighting system of the laundry appliance, determining that the target illumination sequence matches the recorded illumination sequence, and sending a command to the laundry appliance to initiate an operating cycle in response to determining that the target illumination sequence matches the recorded illumination sequence.

In another exemplary embodiment, a method of operating a laundry appliance is provided. The laundry appliance is in operative communication with a remote server through a network. The method includes receiving, from the remote server, a command to generate a target illumination sequence using a lighting system of the laundry appliance, generating the target illumination sequence using the lighting system of the laundry appliance, and receiving, from the remote server, a command to initiate an operating cycle of the laundry appliance.

In yet another exemplary embodiment, a method of using a remote user device to operate a laundry appliance is provided. The remote user device is in operative communication with a remote server through a network. The method includes communicating an appliance identification of the laundry appliance to the remote server, obtaining, using a camera of the remote user device, a recorded illumination sequence generated by a lighting system of the laundry appliance, and transmitting the recorded illumination sequence to the remote server.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an exemplary laundry appliance according to exemplary embodiments of the present disclosure.

FIG. 2 provides a side cross-sectional view of the exemplary laundry appliance of FIG. 1.

FIG. 3 illustrates a system diagram and communication steps for commissioning a laundry appliance using an illumination sequence of the laundry appliance according to an example embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

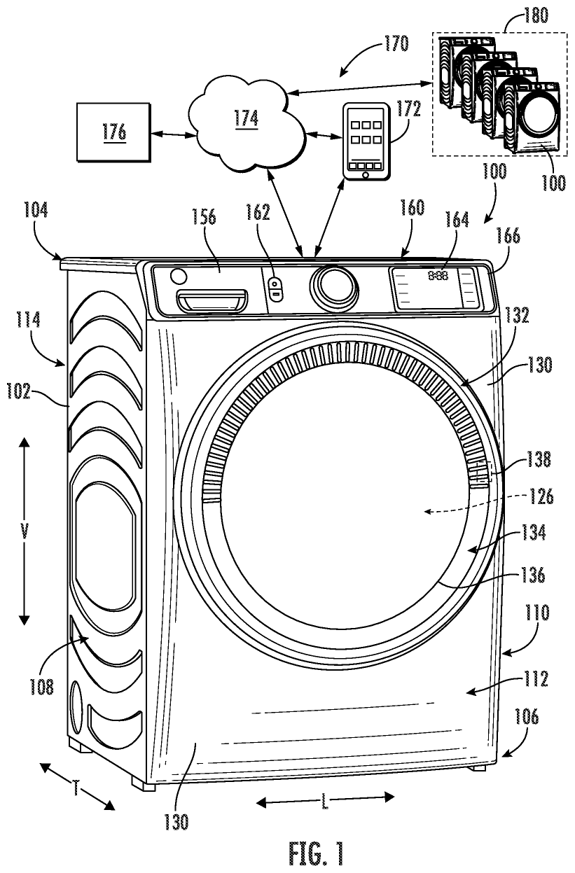

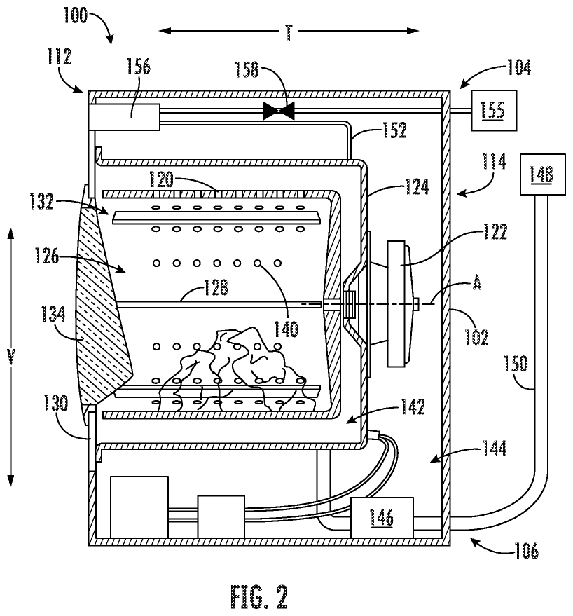

Referring now to the figures, an exemplary laundry appliance that may be used to implement aspects of the present disclosure will be described. Specifically, FIG. 1 is a perspective view of an exemplary laundry appliance provided as a horizontal axis washing machine appliance 100. FIG. 2 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined.

According to exemplary embodiments, washing machine appliance 100 includes a cabinet 102 that is generally configured for containing or supporting various components of washing machine appliance 100 and which may also define one or more internal chambers or compartments of washing machine appliance 100. In this regard, as used herein, the terms “cabinet,” “housing,” and the like are generally intended to refer to an outer frame or support structure for washing machine appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of washing machine appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing washing machine appliance 100.

Referring to FIG. 2, a wash basket 120 is rotatably mounted within cabinet 102 such that it is rotatable about an axis of rotation A. A motor 122, e.g., such as a pancake motor, is in mechanical communication with wash basket 120 to selectively rotate wash basket 120 (e.g., during an agitation or a rinse cycle of washing machine appliance 100). Wash basket 120 is received within a wash tub 124 and defines a laundry or wash chamber 126 that is configured for receipt of articles for laundering (e.g., washing). The wash tub 124 holds wash and rinse fluids for agitation in wash basket 120 within wash tub 124. As used herein, “wash fluid” may refer to water, detergent, fabric softener, bleach, or any other suitable wash additive or combination thereof. Indeed, for simplicity of discussion, these terms may all be used interchangeably herein without limiting the present disclosure to any particular “wash fluid.”

Wash basket 120 may define one or more agitator features that extend into wash chamber 126 to assist in agitation and cleaning articles disposed within wash chamber 126 during operation of washing machine appliance 100. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 102 also includes a front panel 130 which defines an opening 132 that permits user access to wash basket 120 of wash tub 124. More specifically, washing machine appliance 100 includes a door 134 that is positioned over opening 132 and is rotatably mounted to front panel 130. In this manner, door 134 permits selective access to opening 132 by being movable between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 100. Door 134 also includes a handle (not shown) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments. Washing machine appliance 100 may further include a latch assembly 138 (see FIG. 1) that is mounted to cabinet 102 or door 134 for selectively locking door 134 in the closed position or confirming that the door is in the closed position. Latch assembly 138 may be desirable, for example, to ensure only secured access to wash chamber 126 or to otherwise ensure and verify that door 134 is closed during certain operating cycles or events.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140.

A drain pump assembly 144 is located beneath wash tub 124 and is in fluid communication with sump 142 for periodically discharging soiled wash fluid from washing machine appliance 100. Drain pump assembly 144 may generally include a drain pump 146 which is in fluid communication with sump 142 and with an external drain 148 through a drain hose 150. During a drain cycle, drain pump 146 urges a flow of wash fluid from sump 142, through drain hose 150, and to external drain 148. More specifically, drain pump 146 includes a motor (not shown) which is energized during a drain cycle such that drain pump 146 draws wash fluid from sump 142 and urges it through drain hose 150 to external drain 148.

Washing machine appliance 100 may further include a wash fluid dispenser that is generally configured for dispensing a flow of water, wash fluid, etc. into wash tub 124. For example, a spout 152 is configured for directing a flow of fluid into wash tub 124. For example, spout 152 may be in fluid communication with a water supply 154 (FIG. 2) in order to direct fluid (e.g., clean water or wash fluid) into wash tub 124. Spout 152 may also be in fluid communication with the sump 142. For example, pump assembly 144 may direct wash fluid disposed in sump 142 to spout 152 in order to circulate wash fluid in wash tub 124.

As illustrated in FIG. 2, a detergent dispenser 156 is slidably mounted within front panel 130. Detergent dispenser 156 receives a wash additive (e.g., detergent, fabric softener, bleach, or any other suitable liquid or powder) and directs the fluid additive to wash tub 124 during operation of washing machine appliance 100. According to the illustrated embodiment, detergent dispenser 156 may also be fluidly coupled to spout 152 to facilitate the complete and accurate dispensing of wash additive. It should be appreciated that according to alternative embodiments, these wash additives could be dispensed automatically via a bulk dispensing unit (not shown). Other systems and methods for providing wash additives are possible and within the scope of the present disclosure.

In addition, a water supply valve 158 may provide a flow of water from a water supply source (such as a municipal water supply 154) into detergent dispenser 156 and into wash tub 124. In this manner, water supply valve 158 may generally be operable to supply water into detergent dispenser 156 to generate a wash fluid, e.g., for use in a wash cycle, or a flow of fresh water, e.g., for a rinse cycle. It should be appreciated that water supply valve 158 may be positioned at any other suitable location within cabinet 102. In addition, although water supply valve 158 is described herein as regulating the flow of “wash fluid,” it should be appreciated that this term includes, water, detergent, other additives, or some mixture thereof.

During operation of washing machine appliance 100, laundry items are loaded into wash basket 120 through opening 132, and washing operation is initiated through operator manipulation of one or more input selectors or using a remote device (see below). Wash tub 124 is filled with water, detergent, or other fluid additives, e.g., via spout 152 or detergent dispenser 156. One or more valves (e.g., water supply valve 158) can be controlled by washing machine appliance 100 to provide for filling wash basket 120 to the appropriate level for the amount of articles being washed or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle or after the rinse cycle in order to wring wash fluid from the articles being washed. During a final spin cycle, basket 120 is rotated at relatively high speeds and drain assembly 144 may discharge wash fluid from sump 142. After articles disposed in wash basket 120 are cleaned, washed, or rinsed, the user can remove the articles from wash basket 120, e.g., by opening door 134 and reaching into wash basket 120 through opening 132.

Referring again to FIG. 1, washing machine appliance 100 may include a control panel 160 that may represent a general-purpose Input/Output (“GPIO”) device or functional block for washing machine appliance 100. In some embodiments, control panel 160 may include or be in operative communication with one or more user input devices 162, such as one or more of a variety of digital, analog, electrical, mechanical, or electro-mechanical input devices including rotary dials, control knobs, push buttons, toggle switches, selector switches, and touch pads. Additionally, washing machine appliance 100 may include a display 164, such as a digital or analog display device generally configured to provide visual feedback regarding the operation of washing machine appliance 100. For example, display 164 may be provided on control panel 160 and may include one or more status lights, screens, or visible indicators. According to exemplary embodiments, user input devices 162 and display 164 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Washing machine appliance 100 may further include or be in operative communication with a processing device or a controller 166 that may be generally configured to facilitate appliance operation. In this regard, control panel 160, user input devices 162, and display 164 may be in communication with controller 166 such that controller 166 may receive control inputs from user input devices 162, may display information using display 164, and may otherwise regulate operation of washing machine appliance 100. For example, signals generated by controller 166 may operate washing machine appliance 100, including any or all system components, subsystems, or interconnected devices, in response to the position of user input devices 162 and other control commands. Control panel 160 and other components of washing machine appliance 100 may be in communication with controller 166 via, for example, one or more signal lines or shared communication busses. In this manner, Input/Output (“I/O”) signals may be routed between controller 166 and various operational components of washing machine appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 166 may be constructed without using a microprocessor, e.g., using a combination of discrete analog or digital logic circuitry (such as switches, amplifiers, integrators, comparators, flip-flops, OR gates, and the like) to perform control functionality instead of relying upon software.

Controller 166 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor of controller 166 or may be included onboard within such a processor. In addition, these memory devices can store information or data accessible by the one or more processors of controller 166, including instructions that can be executed by the one or more processors. It should be appreciated that the instructions can be software written in any suitable programming language or can be implemented in hardware. Additionally, or alternatively, the instructions can be executed logically or virtually using separate threads on one or more processors.

For example, controller 166 may be operable to execute programming instructions or micro-control code associated with an operating cycle of washing machine appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 166 as disclosed herein is capable of and may be operable to perform one or more methods, method steps, or portions of methods of appliance operation.

The memory devices of controller 166 may also store data that can be retrieved, manipulated, created, or stored by the one or more processors or portions of controller 166. The data can include, for instance, data to facilitate performance of methods described herein. The data can be stored locally (e.g., on controller 166) in one or more databases or may be split up so that the data is stored in multiple locations. In addition, or alternatively, the one or more database(s) can be connected to controller 166 through any suitable network(s), such as through a high bandwidth local area network (LAN) or wide area network (WAN). In this regard, for example, controller 166 may further include a communication module or interface that may be used to communicate with one or more other component(s) of washing machine appliance 100, controller 166, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Referring again to FIG. 1, a schematic diagram of an external communication system 170 will be described according to an exemplary embodiment of the present subject matter. In general, external communication system 170 is configured for permitting interaction, data transfer, and other communications between multiple discrete devices, such as a laundry appliance or more remote user devices. For example, this communication may be used to provide and receive operating parameters, user instructions or notifications, user preferences, or any other suitable information for engagement with washing machine appliance 100. In addition, it should be appreciated that external communication system 170 may be used to transfer data or other information to improve user interaction with laundry appliance or one or more remote user devices.

For example, external communication system 170 may permit controller 166 of washing machine appliance 100 to communicate with a separate device external to washing machine appliance 100, referred to generally herein as a remote user device 172. As described in more detail below, these communications may be facilitated using a wired or wireless connection, such as via a network 174. In general, remote user device 172 may be any suitable device separate from washing machine appliance 100 that is configured with an owner account to provide or receive communications, information, data, or commands from a user. In this regard, remote user device 172 may be, for example, a personal phone, a smartphone, a tablet, a laptop or personal computer, a wearable device, a smart home system, or another mobile or external device.

In addition, a remote server 176 may be in communication with washing machine appliance 100 or remote user device 172 through network 174. In this regard, for example, remote server 176 may be a cloud-based server 176, and is thus located at a distant location, such as in a separate state, country, etc. Generally remote server 176 may include a controller (not shown) that may be the same or similar to controller 166 described above. According to an exemplary embodiment, remote user device 172 may communicate with remote server 176 over network 174, such as the Internet, to transmit/receive data or information, provide user inputs, receive user notifications or instructions, interact with or control washing machine appliance 100, etc. In addition, remote user device 172 and remote server 176 may communicate with washing machine appliance 100 to communicate similar information.

According to an example embodiment, the remote user device 172 may include or be able to access a software application for interacting with the laundromat appliances. For instance, the remote user device 172 may be provided or associated with a particular user profile (e.g., an owner account) to interact with and operate each of the laundromat appliances. Using this software application, the user may maintain an account balance for paying for the use of laundromat appliances, may interact with and control such appliances, etc. For instance, the remote user device 172 may be provided or associated with a particular user profile (e.g., a consumer account) to interact with and operate each of the laundromat appliances. Such a profile may include physical or digital wallets that contain credits (e.g., coupons, tokens, or digital currency) for performing one or more cycles of the various washers and dryers within a laundromat. Remote server 176 may be in communication with remote user device 172 through network 174.

External communication system 170 is described herein according to an exemplary embodiment of the present disclosure. However, it should be appreciated that the exemplary functions and configurations of external communication system 170 provided herein are used only as examples to facilitate description of aspects of the present disclosure. System configurations may vary, other communication devices may be used to communicate directly or indirectly with one or more associated appliances, other communication protocols and steps may be implemented, etc. These variations and modifications are contemplated as within the scope of the present disclosure.

While described in the context of a specific embodiment of horizontal axis washing machine appliance 100, using the teachings disclosed herein it will be understood that horizontal axis washing machine appliance 100 is provided by way of example only. Other laundry appliances having different configurations, different appearances, or different features may also be utilized with the present subject as well. Such laundry appliances may include a vertical axis washing machine appliance, dryer appliance, combined washer/dryer appliance, etc., as would be understood in light of the present disclosure.

Referring still to FIG. 1, washing machine appliance 100 may be utilized as a commercial washer in a laundromat or another commercial setting. In this regard, as used herein, discussion of the use of laundry appliances in a commercial setting may generally refer to the use of the appliance in any location where one or more appliances are provided for temporary use by consumers or users who do not own the appliance(s). These commercial settings may include laundromats that include a large number of washers and dryers that are configured for pay-per-use operation, e.g., via cash, coins, digital currency, or other forms of payment. Additionally or alternatively, these commercial settings may include rental properties (e.g., short-term or long-term rental properties) in which a temporary, non-owner user or guest will have access to the appliance(s) for only a limited (e.g., predetermined) period of time.

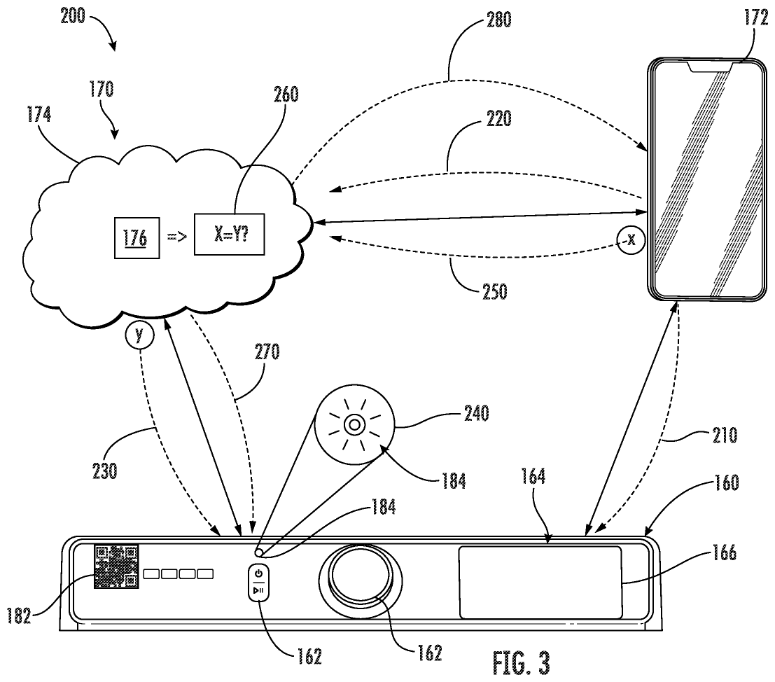

For example, as shown in FIG. 1, washing machine appliance 100 may be located in a commercial environment (e.g., as identified generally by reference numeral 180) along with other washing machine appliances, dryer appliances, etc. In some embodiments, each of the laundry appliances (e.g., washers or dryers) includes an appliance identifier or designation 182 (FIG. 3) to identify a particular laundry appliance at a remote user device 172 or remote server 176. Such an identifier 182 may be embedded or stored (e.g., within a corresponding controller 166 to be displayed at the display 164). Additionally or alternatively, the appliance identifier 182 may be encoded in a bar code, such as a QR code (e.g., as shown in FIG. 3) applied or fixed to a portion of the appliance (e.g., on the corresponding cabinet or control panel). Further additionally or alternatively, the appliance identifier may include a serial number or MAC address of the washing machine appliance. Yet further additionally or alternatively, the appliance identifier 182 may include a predetermined access code for adding a guest account to the notification table associated with a particular laundry appliance.

According to example embodiments, washing machine appliance 100 (and other appliances within commercial environment 180) may incorporate a light source 184, such as a light emitting diode (LED) provided on control panel 160, to emit an encoded remote connection request in the form of a lighting sequence or series of flashes of the light source 184. A single light source 184 may be utilized to emit a predetermined lighting sequence or a plurality of lighting sequences. According to some embodiments, a single LED associated with an identifier on control panel 160 (e.g., a spin cycle notification, a fill notification, a cycle pause notification, etc.) is selectively activated and deactivated to emit the predetermined lighting pattern. According to still other embodiments, a plurality of light sources 184 or any portion of display 164 may be used to communicate the same or similar information.

Now that the construction of washing machine appliance 100 and the configuration of controller 166 according to exemplary embodiments have been presented, an exemplary method 200 of operating a washing machine appliance will be described. In this regard, method 200 provides an example method for engaging or commissioning a laundry appliance, e.g., particularly a laundry appliance in a commercial, pay-per-use setting. Advantageously, method 200 may permit easy engagement of a laundry appliance for operation by a temporary, non-owner user. Although the discussion below refers to the exemplary method 200 of operating washing machine appliance 100, one skilled in the art will appreciate that the exemplary method 200 is applicable to the operation of a variety of other washing machine appliances, such as vertical axis washing machine appliances, dryer appliances, etc. In exemplary embodiments, the various method steps as disclosed herein may be performed by controller 166, remote server 176, remote user device 172, etc.

Referring now to FIG. 3, method 200 includes, at step 210, requesting the initiation of an operating cycle of a laundry appliance. Specifically, according to example embodiments, step 210 may include interacting with washing machine appliance 100 to request an operating cycle within commercial environment 180. In general, the process of requesting the initiation of an operating cycle may include a user entering a commercial environment 180 (e.g., such as a laundromat) and identifying a laundry appliance that is not being used, e.g., such as washing machine appliance 100. As explained above, the user may wish to use washing machine appliance 100 by commissioning for paying for a session of appliance usage.

Notably, as explained above, a user may use a remote user device 172 (e.g., such as a user's cell phone) to interact with washing machine appliance 100, to input operating parameters for an operating cycle, and to commission or pay for an appliance operating session, etc. For example, step 210 may further include using a software application on remote user device 172 to engage washing machine appliance 100 and communicate operating parameters (e.g., such as the desired wash program, operating temperatures, cycle settings, etc.). According to alternative example embodiments, these communications may be communicated to washing machine appliance 100 indirectly through network 174.

In order to facilitate use of the appliance, remote server 176 may need to be aware of the specific appliance whose operation is being requested. Accordingly, step 210 may further include obtaining and communicating an identification code of the laundry appliance to the remote server. For example, the communication of such data is identified in FIG. 3 by reference numeral 220. According to example embodiments, the transmission of the appliance identification may include a communication of a barcode, a QR code, a serial number, or any other suitable address or identification of the appliance. For example, according to the illustrated embodiment, a user may utilize a camera (not labeled) of remote user device 172 to obtain a picture of QR code 182 and may transmit this appliance identification to remote server 176. Based on this appliance identification 182, remote server 176 may establish a communication link directly with washing machine appliance 100.

As explained briefly above, appliance regulations may require a user to prove their presence in front of a laundry appliance prior to initiating an operating cycle. This may typically be done by relying on the user to physically press the start button (e.g., such as a user input device 162). However, a user may not wish to touch washing machine appliance 100 (e.g., for sanitary concerns) or may otherwise wish to interact with the appliance solely through the remote user device 172 for convenience. Accordingly, method 200 may include steps for ensuring the presence of a user in front of washing machine appliance 100 without such physical user interaction.

Specifically, step 230 may include communicating to the laundry appliance a target illumination sequence to be generated by a lighting system of the laundry appliance. Continuing the example from above, remote server 176 may transmit, and washing machine appliance 100 may receive, a target illumination sequence for illuminating one or more light sources (e.g., such as light source 184). Step 240 includes generating the target illumination sequence at washing machine appliance 100. In this regard, controller 166 may operate light source 184 in accordance with the instructions related to the target illumination sequence from remote server 176.

In general, the target illumination sequence may be a specific pattern, sequence, or display by the lighting system that may be used to identify the specific target laundry appliance. For example, the target illumination sequence may be a blinking pattern for a single light or a sequence of illumination of a plurality of lights and may include encoded information or identification patterns. This target illumination pattern may be identified by the letter “y” in FIG. 3.

Step 250 may include recording and transmitting the generated illumination sequence from the target appliance. In this regard, a user may record a recorded illumination sequence of light source 184, e.g., using a camera of remote user device 172. The recorded illumination sequence may be identified by the letter “x” in FIG. 3 and may include a video of the operation of light source 184 or any other suitable representation of the sequence of lighting generated by the appliance lighting system or displays. In this regard, the software application used to input operating parameters and request interaction with a particular appliance may transmit the appliance identification (e.g., as described with respect to step 210) may provide the user with interactive guidance to help the user focus the camera of remote user device 172 on the lighting system in a manner that records and generates the recorded illumination sequence.

After the recorded illumination sequence is obtained, remote user device 172 may transmit the recorded illumination sequence to remote server 176. Notably, if the target illumination sequence and the recorded illumination sequence are the same or substantially similar, this may indicate that the user of remote user device 172 is physically present in front of washing machine appliance 100. Accordingly, step 260 may include determining that the target illumination sequence matches the recorded elimination sequence. This regard, remote server 176 may compare what it commanded the lighting system of the laundry appliance to do with what a user actually recorded the laundry appliance doing. If the two actions are the same, the user account may be associated with a washing machine appliance, an operating session may be commissioned, and an operating cycle may be performed.

In this regard, step 270 may include sending a command to the appliance to initiate an operating cycle (e.g., with operating parameters communicated at step 220) in response to determining that the target illumination sequence matches the recorded illumination sequence. According to alternative example embodiments, instead of directly and immediately initiating an operating cycle upon confirming a match between the target and recorded illumination sequence, step 270 may include sending a prompt to remote user device 172. The prompt may indicate that the target illumination sequence matches the recorded elimination sequence and may request user confirmation to initiate an operating cycle. In this regard, the software application on remote user device 172 may display a virtual start button that a user may press to initiate the operating cycle.

Notably, method 200 may further include determining that the target illumination sequence does not match the recorded illumination sequence. In such an instance, remote server 176 may take no further action with the laundry appliance and may communicate to the remote user device 172 that the target illumination sequence and the recorded illumination sequence do not match. The communication may also include an explanation or instructions to the user as to how they may properly commission another laundry appliance.

FIG. 3 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 are explained using washing machine appliance 100 as an example, it should be appreciated that these methods may be applied to the operation of any suitable washing machine appliance.

As explained above, aspects of the present subject matter are generally directed to a method of starting a cycle in a commercial laundry using a remote software application, e.g., on a user's mobile phone, utilizing LED light blinking. The method may allow a user to start a cycle without making any contact with the laundry machine. The software application may allow a user to create a session for a laundry appliance by inputting an appliance ID of the laundry machine, and selecting the wash program, water temperature, etc. When the user presses continue button on the app, the cloud may send a randomized LED blinking data to the laundry machine. The user may record the LED blinking on the laundry machine via the software application and a mobile phone camera. The recorded blinking may be uploaded to the cloud, and if the captured pattern matches with the pattern in the cloud, the laundry machine may start a cycle without pressing any button in the machine. If the pattern does not match, the software application may display an error pop-up message.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of using a remote server to operate a laundry appliance, the remote server being in operative communication with the laundry appliance and a remote user device through a network, the method comprising:
communicating, to the laundry appliance, a target illumination sequence to be generated by a lighting system of the laundry appliance;
receiving, from the remote user device, a recorded illumination sequence generated by the lighting system of the laundry appliance;
determining that the target illumination sequence matches the recorded illumination sequence; and
sending a command to the laundry appliance to initiate an operating cycle in response to determining that the target illumination sequence matches the recorded illumination sequence.

2. The method of claim 1, wherein the target illumination sequence comprises:
a blinking pattern for a single light of the lighting system of the laundry appliance.

3. The method of claim 1, wherein the target illumination sequence comprises:
a sequence of illumination of a plurality of lights of the lighting system of the laundry appliance.

4. The method of claim 1, wherein the recorded illumination sequence is a video obtained using the remote user device.

5. The method of claim 1, wherein sending the command to the laundry appliance to initiate the operating cycle comprises:
sending a prompt to the remote user device indicating that the target illumination sequence matches the recorded illumination sequence and requesting user confirmation to initiate the operating cycle.

6. The method of claim 1, further comprising:
receiving, from the remote user device, an appliance identification of the laundry appliance.

7. The method of claim 1, further comprising:
determining that the target illumination sequence does not match the recorded illumination sequence; and
providing an error notification to the remote user device.

8. A method of operating a laundry appliance, the laundry appliance being in operative communication with a remote server through a network, the method comprising:
receiving, from the remote server, a command to generate a target illumination sequence using a lighting system of the laundry appliance;
generating the target illumination sequence using the lighting system of the laundry appliance; and
receiving, from the remote server, a command to initiate an operating cycle of the laundry appliance.

9. The method of claim 8, wherein the target illumination sequence comprises:
a blinking pattern for a single light of the lighting system of the laundry appliance.

10. The method of claim 8, wherein the target illumination sequence comprises:
a sequence of illumination of a plurality of lights of the lighting system of the laundry appliance.

11. The method of claim 8, further comprising:
receiving confirmation that the target illumination sequence matches a recorded illumination sequence.

12. The method of claim 8, further comprising:
receiving, from a remote user device, operating parameters of the operating cycle.

13. A method of using a remote user device to operate a laundry appliance, the remote user device being in operative communication with a remote server through a network, the method comprising:
communicating an appliance identification of the laundry appliance to the remote server;
obtaining, using a camera of the remote user device, a recorded illumination sequence generated by a lighting system of the laundry appliance; and
transmitting the recorded illumination sequence to the remote server.

14. The method of claim 13, further comprising:
scanning the identification code using a camera of the remote user device.

15. The method of claim 13, wherein the identification code is a QR code displayed on a front of the laundry appliance.

16. The method of claim 13, further comprising:
providing interactive guidance to help a user focus the camera on lighting system of the laundry appliance.

17. The method of claim 13, further comprising:
communicating, to the laundry appliance, operating parameters of an operating cycle.

18. The method of claim 13, wherein the recorded illumination sequence is a video obtained using the remote user device.

19. The method of claim 13, further comprising:
receiving a prompt from the remote server indicating that a target illumination sequence matches the recorded illumination sequence and requesting user confirmation to initiate an operating cycle.

20. The method of claim 13, further comprising:
receiving an error notification from the remote server indicating that a target illumination sequence does not match the recorded illumination sequence.
